(19) United States
(12) Patent Application Publication
(10) Pub. No.: US 2006/0018189 A1
(43) Pub. Date: Jan. 26, 2006

(54) Juice blender

(76) Inventor: Sung Shan Chang Chien, Kaohsiung Hsien (TW)

Correspondence Address: LEONG C LEI, PMB # 1008, 1867 YGNACIO VALLEY ROAD, WALNUT CREEK, CA, 94598, US

(21) Appl. No.: 10/898,213

(22) Filed: Jul. 26, 2004

(51) Int. Cl. B01F 7/00

(52) U.S. Cl. 366/205

(57) ABSTRACT

A juice blender is disclosed. An inner cup is placed within the cup body of the juice blender. The capacity of the inner cup of the juice blender is reduced and the interior of the cup body of the juice blender contains dry foods for blending.

### BACKGROUND OF THE INVENTION

(a) Technical Field of the Invention

The present invention relates to an improved structure of a juice blender. An inner cup is provided within the cup body of the juice blender and accordingly the blender can be used for blending of dry and wet foods.

(b) Description of the Prior Art

The conventional juice blender comprises a base seat 11, a motor 12, a cup body 13, a covering body 14, which is shown in FIG. 1. In operation, an appropriate amount of water is added into the cup body via an opening at the upper end of the juice blender 1. The power switch of the juice blender 1 is turned on and the speed of the blender 1 is selected via a speed selector provided on the blender 1. The motor 12 which drives the blender 1 will not be damaged as the load of wet food stuff will not exceed its maximum load of the motor. However, when the blender 1 is used to blend dry food stuff, the resistance of the dry food stuff is higher and this will cause excessive load to the motor 12. The motor 12 may not be able to function normally and the motor 12 may be damaged if it is operated for an extended time.

In order to overcome the above problem, a smaller capacity cup body 13a is exploited so as to reduce the load of the motor 12. This will cause an increase of cost to provide a cup for blending of dry food. Accordingly, it is an object of the present invention to provide an improved structure of a juice blender which has only one cup for dry and wet food blending, and thus, the cost of manufacturing the blender is greatly reduced.

### SUMMARY OF THE INVENTION

Accordingly, it is an object of the present invention is to provide a juice blender including a base seat mounted with a motor, a cup body disposed with a blade, an inner cup and a cup cover, characterized in that the upper portion of the inner cup is a funnel shape and the bottom portion of the inner cup is a circular container with an upper portion mounted with a securing rim, the outer end of the securing rim is provided with a plurality of recesses corresponding to protruded ribs within the cup body, the engagement of the recesses with the ribs stabilizes the inner cup within the cup body and the circular container portion of the inner cup defines the capacity of the cup and the effective capacity reduces the load of the motor of the juice blender.

Yet another object of the present invention is to provide a juice blender, wherein the inner side of the circular tank portion of the inner cup is provided with a plurality of protruded ribs.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional juice blender.

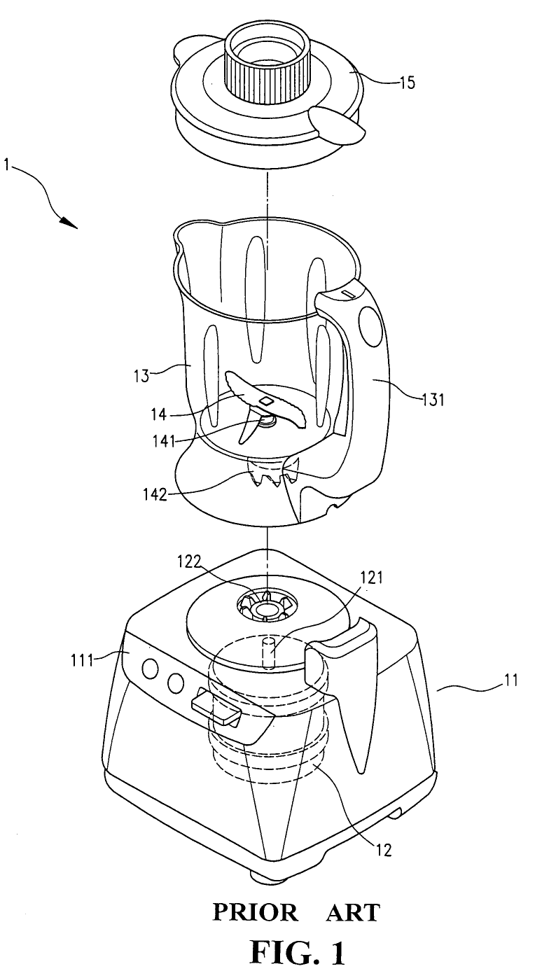

FIG. 2 is a perspective view of another conventional juice blender.

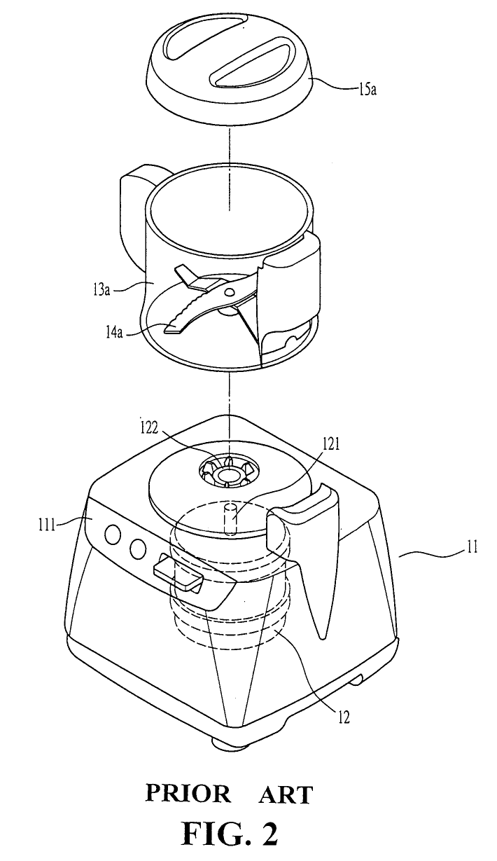

FIG. 3 is a perspective exploded view of the juice blender of the present invention.

FIG. 4 is a perspective view of the juice blender of the present invention.

FIG. 5 is a preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

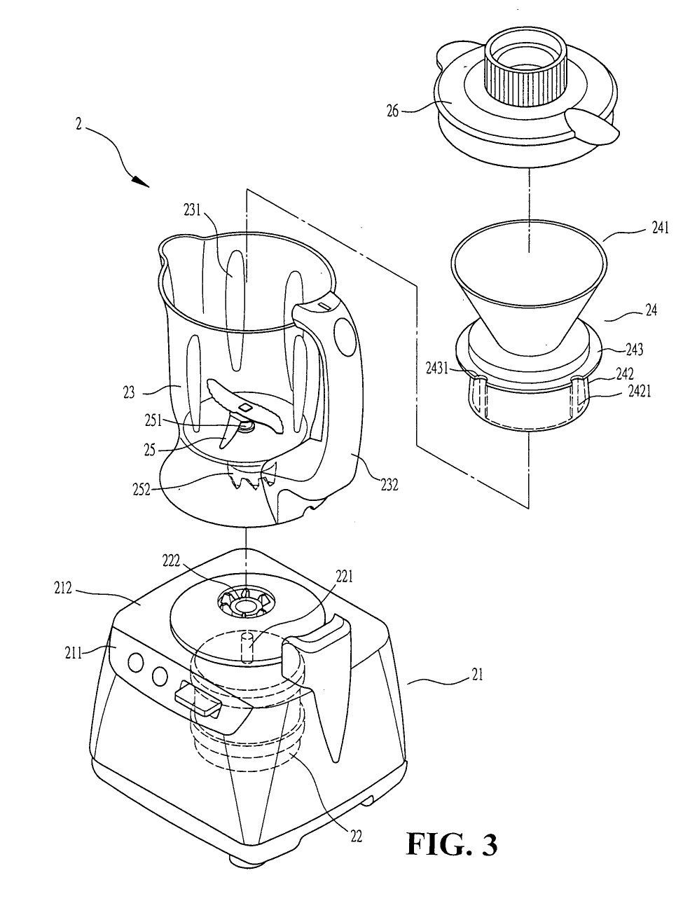

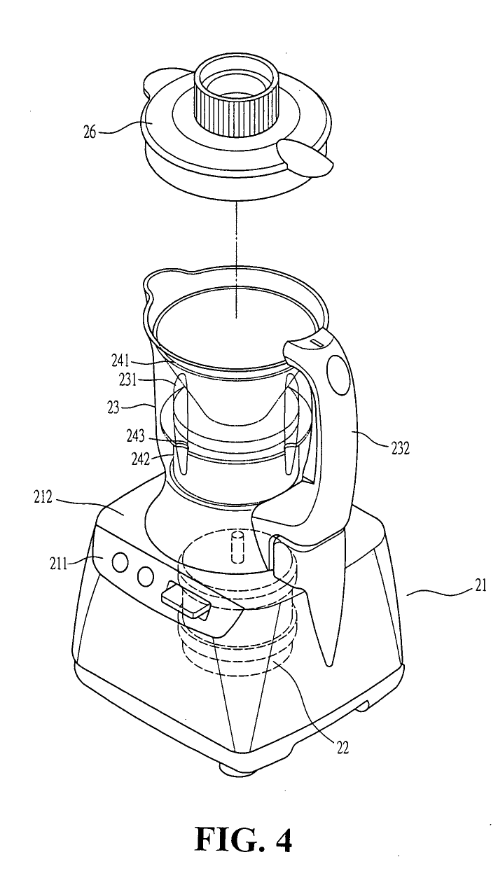

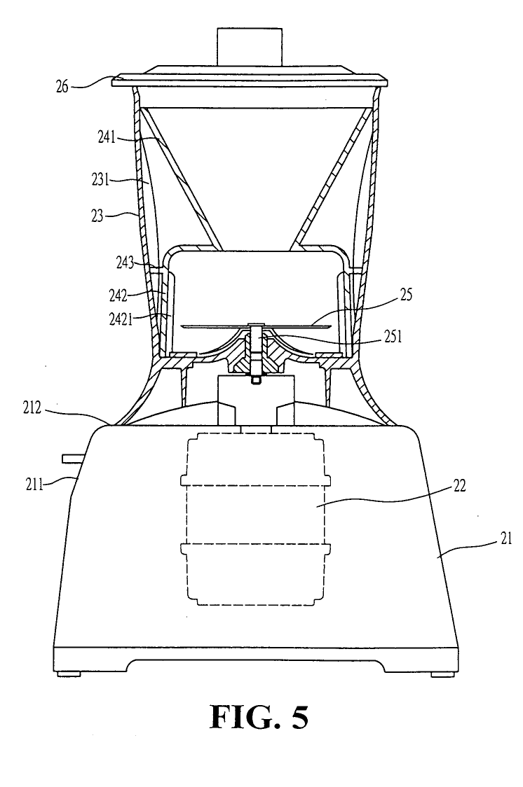

Referring to FIGS. 3 to 5, there is shown a juice blender 2 comprising a base seat 21, a motor 22, a cup body 23, an inner cup 24, a blade 25 and a cup cover 26.

The base seat 21 is mounted with a motor 22 having an output shaft 221 passed through the upper end portion of the base seat 21. The end head portion of the output shaft 221 is mounted with a reamer 222. On one face of the base seat 21 is provided with a control switch module 211 having ON/OFF and speed selection. The upper end of the base seat 21 is provided with a seat platform 212 to hold the cup body 23.

The upper end of the cup body 23 is an open end container body. The bottom portion is disposed with a blade 25. The axle 251 of the blade 25 is extended to the external side of the cup body 23, and the axle 251 end is provided with a reamer 252 corresponding to the reamer 222 extended from the motor 22. The rotation of the blade 25 is driven by the motor via the reamers 252, 222. The bottom of the cup body 23 and the seat platform 212 of the seat base 21 are corresponding to each other. This will allow the cut to firmly place on the base seat 21. The circumferential edge of the cup body 23 is provided with a plurality of ribs 231 to block food while food stuff is minced by the blade 25. A handle 232 is provided to one side of the cup body 23 allowing the withdrawal of the cup.

The inner cup 24 is a through container body having an upper end being a funnel shape mechanism 241. The lower end portion is a tapered circular container portion 242. The upper end is extended to form securing rim bodies 243 having a bottom end provided with a plurality of recesses 2431, corresponding to the protruded ribs 231 of the cup body 23. The engagement of the recesses 2431 and the ribs 231 can stable the cup body 23, and circular tank portion 242 at the bottom portion of the inner cup 24 defines a cavity which is the effective capacity of the cup. The inner portion of the circular tank portion 242 is provided with a plurality of ribs 2421. The ribs 2421 blocks the food stuff and allows effective mincing of the stuff. The height of the inner cup 24 is lower than the cup body 23. This will facilitate the covering by a cup cover 26.

The cup cover 26 has a shape similar to the opening of the cup body 23. When the juice blender 2 is in operation, the blended food stuff is prevented from coming out from the opening of the cup body.

When the blender of the present invention is used to blend dry stuff, the inner cup 24 is placed into the cup body 23. The recesses 2431 of the rim bodies 243 engages with the protruded ribs 231 of the cup body 23 so as to stable the inner cup 24 at the cup body 23. Dry food stuff is placed through the funnel shape mechanism 241. The cup body is cover with the cup cover 26. The lower end of the cup cover 26 can press the upper end edge of the funnel mechanism 241. This will further stable the cup body 23. The circular tank portion 242 of the inner cup 24 defines the capacity, which is the capacity of the blended dry food stuff. This capacity is lower than the capacity of the original cup body 23. When dry food stuff is blended, the load of the motor 22 will not be increased, and this will not cause damage to a motor 22.

The blender of the present invention provides an inner cup 24 within the cup body 23 which allows dry and wet blending of food stuff. Thus, the cost of manufacturing of the blender is greatly reduced.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A juice blender including a base seat mounted with a motor, a cup body disposed with a blade, an inner cup and a cup cover, characterized in that the upper portion of the inner cup is a funnel shape and the bottom portion of the inner cup is a circular container with an upper portion mounted with a securing rim, the outer end of the securing rim is provided with a plurality of recesses corresponding to protruded ribs within the cup body, the engagement of the recesses with the ribs stabilizes the inner cup within the cup body and the circular container portion of the inner cup defines the capacity of the cup and the effective capacity reduces the load of the motor of the juice blender.

2. The juice blender of claim 1, wherein the inner side of the circular tank portion of the inner cup is provided with a plurality of protruded ribs.
